(19) United States
(12) Patent Application Publication
(10) Pub. No.: US 2008/0259014 A1
(43) Pub. Date: Oct. 23, 2008

(54) LIQUID CRYSTAL DISPLAY DEVICE

(75) Inventor: Daisuke INOUE, Kanagawa (JP)

Correspondence Address: YOUNG & THOMPSON, 209 Madison Street, Suite 500, ALEXANDRIA, VA, 22314, US

(73) Assignee: NEC LCD TECHNOLOGIES, LTD., KANAGAWA (JP)

(21) Appl. No.: 12/103,820

(22) Filed: Apr. 16, 2008

(30) Foreign Application Priority Data
Apr. 17, 2007 (JP) 2007-108753

(51) Int. Cl. G09G 3/36; G09G 5/10

(52) U.S. Cl. 345/89; 345/690

(57) ABSTRACT

A liquid crystal display device prevents the gray level folding in at least one of the vicinities of the highest and lowest gray levels while avoiding the complication of the data line driver circuit. The data line driver circuit generates output voltages whose number is equal to a predetermined gray level number M based on reference voltages, and selects one of the output voltages and outputs the selected one to the display section in response to an inputted image signal, thereby displaying images The applied voltage-brightness characteristic of the display section has a zero brightness change region in which the reference voltage corresponding to the highest gray level is located. The reference voltage corresponding to the next lower level to the highest level is set such that the brightness at the next lower level is lower than that at the highest level by a predetermined difference.

### BACKGROUND OF THE INVENTION

1. Field of the Invention

The present invention relates to a Liquid Crystal Display (LCD) device and more particularly, to a LCD device that improves the time-varying or moving image displaying performance in the Twisted Nematic (TN) mode.

2. Description of the Related Art

The LCD device comprises a transparent substrate on which switching elements such as Thin-Film Transistors (TFTs) are formed (which is usually termed the “TFT substrate” or “driver substrate”), another transparent substrate on which a color filter and a black matrix are formed (which is usually termed the “color filter (CF) substrate” or “opposite substrate”), and a liquid crystal layer sandwiched between the TFT substrate and the CF substrate. An electric field is applied across the electrodes formed on the TFT substrate and those on the CF substrate, or across the electrodes that are formed on the TFT substrate, thereby changing the alignment direction of the liquid crystal molecules in the liquid crystal layer. Thus, the amount of the transmitted light in each pixel is controlled, thereby displaying desired images.

As the typical display modes of the LCD device, the TN mode and the In-Plane Switching (IPS) mode are known. With the TN mode, an electric field perpendicular to the TFT and CF substrates is generated using the electrodes formed on the TFT substrate and those formed on the CF substrate, and the liquid crystal molecules are selectively rotated by the electric field to the vertical direction with respect to the TFT and CF substrates, thereby displaying desired images. On the other hand, with the IPS mode, an electric field parallel to the TFT and CF substrates is generated using the electrodes formed on the TFT substrate, and the liquid crystal molecules are selectively rotated by the electric field in planes parallel to the TFT and CF substrates, thereby displaying desired images.

Conventionally, the LCD device was used extensively as high-resolution display devices for computers; however, in recent years, it has been becoming used as the televisions also. Because the LCD device designed for the television necessitates wide viewing angles and high time-varying or moving image displaying performance, the Vertical Alignment (VA) mode has been used in addition to the aforementioned IPS mode. With the VA mode, the liquid crystal molecules are initially aligned in a direction perpendicular to the TFT and CF substrates and then, they are selectively inclined toward planes parallel to the said substrates by an electric field, thereby displaying desired images. To display high-quality time-varying images, an effort to improve the response characteristic of the liquid crystal in the VA mode has been being made.

However, the improvement of the viewing angle compensation film made it possible to realize wide viewing angles in the LCD device operating in the TN mode, and therefore, the use of the TN mode for the television has begun recently. For this reason, there is the need for the LCD device operating in the TN mode to display high-quality time-varying images also.

The main stream of the method of driving the LCD device is the active matrix addressing, where the switching elements such as TFTs, which are provided for the respective pixels arranged in a matrix array, are respectively ON-OFF driven to control the voltages applied to the liquid crystal layer in the individual pixels. One measure for improving the time-varying image displaying performance of the active-matrix addressing LCD device is to pay attention to the applied voltage dependency of the response speed of the liquid crystal molecules. An example of this measure is disclosed in the Japanese Patent No. 3511592 issued on Jan. 16, 2004 (which corresponds to the Japanese Non-Examined Patent Publication No. 2002-107694). This patent will be termed the “Patent Document 1” below.

The LCD device disclosed in the Patent Document 1 comprises a display section having a predetermined applied voltage-brightness characteristic, and a signal line (or data line) driver circuit to which first reference voltages and second reference voltages are selectively applied. The first reference voltages are used for supplying predetermined voltages to the liquid crystal in the display section. One of the second reference voltages has a maximum voltage value greater than the highest one of the predetermined voltages to be applied to the liquid crystal. The other of the second reference voltages has a minimum voltage value less than the lowest one of the predetermined voltages to be applied to the liquid crystal. The signal line driver circuit supplies the predetermined voltages to the liquid crystal in the display section using the first reference voltages, realizing desired brightness corresponding to an inputted image signal.

When the voltage value of one of the predetermined voltages, which is to be applied to the liquid crystal in the display section, is changed to the highest one, the signal line driver circuit supplies a voltage whose value is higher than the said highest one to the display section as a compensation voltage, using one of the second reference voltages. Similarly, when the voltage value of one of the predetermined voltages is changed to the lowest one, the signal line driver circuit supplies another voltage whose value is lower than the said lowest one to the display section as another compensation voltage, using the other of the second reference voltages. (See claim 1, FIGS. 1 and 2, and paragraphs 0012 to 0014 of the Patent Document 1.) This LCD device will be termed the “prior art 1” below.

The LCD device of the prior art 1, which displays images with 8 bits (at 256 gray levels or 256 shades of gray), has the applied voltage-brightness characteristic as shown in FIG. 1. In the characteristic of FIG. 1, V0(P) to V17(N) denote the above-described first reference voltages, and V8′(P), V9′(N), V0′(P), and V17′(N) denote the second reference voltages, respectively. The second reference voltages V8′(P) and V9′(N) are used instead of the first reference voltages V8(P) and V9(N), respectively. The second reference voltages V0′(P) and V17′(N) are used instead of the first reference voltages V0(P) and V17(N), respectively.

In this specification, the representation “(P)” means that the voltage has a positive polarity, and the representation “(N)” means that the voltage has a negative one.

The second reference voltages V0′(P) and V17′(N) have values greater than those of the first reference voltages V0(P) and V17(N) as the highest ones of the aforementioned predetermined voltages to be applied to the liquid crystal. The second reference voltages V8′(P) and V9′(N) have values less than those of the first reference voltages V8(P) and V9(N) as the lowest ones of the aforementioned predetermined voltages to be applied to the liquid crystal. Among these first and second reference voltages, the voltages V8(P) and V9(N) corresponding to white display are set at voltage values in such a way as to realize the relative brightness values of approximately 100%, respectively. Similarly, the voltages V0(P) and V17(N) corresponding to black display are set at voltage values in such a way as to realize sufficient contrast ratios, respectively.

In this way, with the LCD device of the prior art 1, the first reference voltages V8(P) and V9(N) corresponding to white display are shifted toward the low voltage side to generate the second reference voltages V8′(P) and V9′(N), respectively. At the same time, the first reference voltages V0(P) and V17(N) corresponding to black display are shifted toward the high voltage side to generate the second reference voltages V0′(P) and V17′(N), respectively. Therefore, the time-varying or moving image displaying performance can be improved.

However, with the LCD device of the prior art 1, the voltage values corresponding to the intermediate tones in the vicinities of white and black (concretely, the gray levels between the first reference voltages V0/V17 and V1/V6 and the gray levels between the first reference voltages V8/V9 and V7/V10), which are calculated from the voltage values corresponding to the black display and the white display, are affected by the above-described shifting. As a result, the gray level-brightness characteristic contains a distortion in the aforementioned intermediate tones, as shown by the thick line curve in FIG. 2. The thin line curve in FIG. 2 indicates the normal gray level-brightness characteristic. Accordingly, a problem of “gray level folding” occurs in the intermediate tones in the vicinities of white and black. Here, the “gray level folding” is a phenomenon that the brightness value does not change in spite of the change of the applied voltage value to the liquid crystal.

To solve the above-described problem of “gray level folding”, the Patent Document 1 discloses another LCD device. With this LCD device, in addition to the first reference voltages V0 to V17 for realizing the predetermined applied voltage-brightness characteristic and the second reference voltages V8′(P), V9′(N), V0′(P), and V17′(N) for voltage shifting, correcting reference voltages VA(P), VB(N), VC(P), and VD(N) are generated for correcting the values of the said second reference voltages. Because of this measure, the response speed of the liquid crystal can be increased without causing the unwanted brightness change in the intermediate tones in the vicinities of white and black. (See FIG. 3 and paragraphs 0015 to 0018 of the Patent Document 1.) This LCD device will be termed the “prior art 2” below.

The LCD device of the prior art 2 has the applied voltage-brightness characteristic as shown in FIG. 3. With this LCD device, the signal line driver circuit comprises correcting reference voltage input terminals for the correcting reference voltages VA(P), VB(N), VC(P), and VD(N), and control signal input terminals for indicating which one of the second reference voltages V8′(P), V9′(N), V0′(P), and V17′(N) and the correcting reference voltages VA(P), VB(N), VC(P), and VD(N) should be selected using the control signal.

When the brightness is changed to the vicinity of white, the correcting reference voltage VA(P) or VB(N) is selected and outputted to the display section using the control signal. Similarly, when the brightness is changed to the vicinity of black, the correcting reference voltage VC(P) or VD(N) is selected and outputted to the display section using the control signal. Accordingly, the response speed of the liquid crystal can be increased without causing the gray level folding in the LCD device of the prior art 2.

However, the above-described LCD device of the prior art 1 has the problem that the gray level folding occurs in the specific regions of the grayscale. On the other hand, the above-described LCD device of the prior art 2 has a problem that the signal line driver circuit is complicated. Therefore, it is desirable to create a measure to display high-quality time-varying images in the TN mode without such problems. Therefore, the inventor made every effort to develop such a measure as above and obtained the following findings.

The response characteristic of the liquid crystal (i.e., brightness change) in the change from black (i.e., the lowest gray level) to white (i.e., the highest gray level) and that from white to black in the LCD device operating in the normally white and TN mode are schematically shown in FIG. 4.

In FIG. 4, the curve 103 indicates schematically the brightness change from black to white, and the curve 104 indicates schematically the brightness change from white to black. It is seen from the curves 103 and 104 that the time tB-W required for the brightness change from black to white is longer than the time tW-B required for the brightness change from white to black. This means that the response speed of the liquid crystal at the rising of brightness is less than that at the falling of brightness in the LCD device operating in the TN mode. Therefore, to improve the time-varying or moving image displaying performance in the LCD device that operates in the TN mode and that is designed for the television, it is found that the important thing is to improve the response characteristic of the liquid crystal at the falling of brightness.

FIG. 5 schematically shows the relationship between the applied voltage to the liquid crystal and the response of the liquid crystal (i.e. brightness change) in the LCD device operating in the normally white and TN mode.

In FIG. 5, the curves 105 and 106 indicate the change of the applied voltage to the liquid crystal. The curve 105 corresponds to the case where the voltage change is small and the curve 106 corresponds to the case where the voltage change is large. The curve 107 indicates the change of the brightness when the applied voltage to the liquid crystal is changed according to the curve 105. Similarly, the curve 108 indicates the change of the brightness when the applied voltage to the liquid crystal is changed according to the curve 106. The values of the applied voltage at the start of the changes according to the curves 105 and 106 are equal to each other; however, the values of the applied voltage at the end of these changes are different.

As seen from FIG. 5, if the applied voltage is changed according to the curve 105 or 106, the brightness varies along the curve 107 or 108 accordingly. Specifically, if the applied voltage is changed according to the curve 105 (in other words, if the variation range of the applied voltage is narrow), the time required for completing the response of the liquid crystal (for completing the brightness change) in response to the change of the applied voltage is given by t2. If the applied voltage is changed according to the curve 106 (in other words, if the variation range of the applied voltage is wide), the time required for completing the response of the liquid crystal (for completing the brightness change) in response to the change of the applied voltage is given by t1, where t1<t2. This means that when the variation width of the applied voltage is relatively wide, the brightness change responsive to the said voltage change is completed earlier. In other words, supposing that the voltage value corresponding to black is constant, the higher the response speed of the liquid crystal at the change from black or a medium gray tone to white, the lower the voltage value corresponding to white.

### SUMMARY OF THE INVENTION

The present invention was created based on the aforementioned findings obtained by the inventor.

An object of the present invention is to provide a LCD device that makes it possible to prevent the gray level folding in at least one of the vicinity of the highest gray level and that of the lowest gray level while avoiding the complication of the data line (or signal line) driver circuit.

Another object of the present invention is to provide a LCD device that realizes the high-quality time-varying or moving image display in the TN mode.

The above objects together with others not specifically mentioned will become clear to those skilled in the art from the following description.

According to the first aspect of the present invention, a LCD device is provided, which comprises:

a display section having a predetermined applied voltage-brightness characteristic about an applied voltage to a liquid crystal and a brightness; and

a driver circuit for driving the display section;

wherein the driver circuit generates output voltages whose number is equal to a predetermined gray level number M based on reference voltages, and selects one of the output voltages and outputs the selected one to the display section in response to an inputted image signal, thereby displaying an image on an M-level gray scale from a 0 level as a lowest level to an (M−1) level as a highest level;

the applied voltage-brightness characteristic of the display section comprises a zero brightness change region where brightness change responsive to change of the applied voltage to the liquid crystal is approximately zero, and the reference voltage corresponding to the highest level of the gray scale is located in the zero brightness change region; and

the reference voltage corresponding to a next lower level to the highest level, which is lower than the highest level by one, is set in such a way that a brightness at the next lower level is lower than a brightness at the highest level by a predetermined brightness difference.

With the LCD device according to the first aspect of the invention, the reference voltage corresponding to the highest level of the M-level gray scale (i.e., the (M−1) level) is located in the zero brightness change region of the applied voltage-brightness characteristic of the display section. Moreover, the reference voltage corresponding to the next lower level to the highest level (i.e., the (M−2) level) is set in such a way that the brightness at the next lower level is lower than the brightness at the highest level by the predetermined brightness difference.

Therefore, the difference between the brightness at the highest level and the brightness at the next lower level thereto can be reduced while the difference between the reference voltage corresponding to the highest level and the reference voltage corresponding to the next lower level is increased. As a result, the gray level folding can be prevented in the vicinity of the highest level of the M-level gray scale.

Further, because the generation of additional reference voltages similar to the correcting reference voltages of the LCD device of the prior art 2 is unnecessary, the above-described problem of the complication of the data line driver circuit does not occur.

Accordingly, the gray level folding can be prevented while the complication of the data line driving circuit is avoided. This means that high-quality time-varying image display in the TN mode can be realized.

In a preferred embodiment of the LCD device according to the first aspect of the invention, when the brightness at the highest level is defined as “brightness(M−1)” and the brightness at the next lower level to the highest level is defined as “brightness(M−2)”, a ratio of the brightness at the next lower level to the brightness at the highest level, [brightness(M−2)/brightness(M−1)], is in a range from 1.2-th power of [(M−2)/(M−1)] to 3.2-th power thereof.

In another preferred embodiment of the LCD device according to the first aspect of the invention, the brightness difference is set in a range from 0.5% to 1.2% of the brightness at the highest level.

In still another preferred embodiment of the LCD device according to the first aspect of the invention, the reference voltage corresponding to the highest level is set in a range from 0% to 6% of the reference voltage corresponding to the lowest level.

In a further preferred embodiment of the LCD device according to the first aspect of the invention, the reference voltage corresponding to the lowest level is set at a voltage in such a way as to realize a desired contrast in a front view of the display section.

According to the second aspect of the present invention, another LCD device is provided, which comprises:

a display section having a predetermined applied voltage-brightness characteristic about an applied voltage to a liquid crystal and a brightness; and

a driver circuit for driving the display section;

wherein the driver circuit generates output voltages whose number is equal to a predetermined gray level number M based on reference voltages, and selects one of the output voltages and outputs the selected one to the display section in response to an inputted image signal, thereby displaying an image on an M-level gray scale from a 0 level as a lowest level to an (M−1) level as a highest level;

the applied voltage-brightness characteristic of the display section comprises a zero brightness change region where brightness change responsive to change of the applied voltage to the liquid crystal is approximately zero, and an imaginary reference voltage lower than the reference voltage corresponding to the lowest level is located in the zero brightness change region; and

the reference voltage corresponding to a next higher level to the lowest level, which is higher than the lowest level by one, is set to be lower than the imaginary reference voltage and is set in such a way that a brightness at the next higher level is higher than a brightness at the lowest level by a predetermined brightness difference.

With the LCD device according to the second aspect of the invention, the imaginary reference voltage, which is lower than the reference voltage corresponding to the lowest level of the M-level gray scale (i.e., the 0 level), is located in the zero brightness change region of the applied voltage-brightness characteristic of the display section. Moreover, the reference voltage corresponding to the next higher level to the lowest level (i.e., the 1 level) is set to be lower than the imaginary reference voltage. The reference voltage corresponding to the next higher level is set in such a way that the brightness at the next higher level is higher than the brightness at the lowest level by the predetermined brightness difference.

Therefore, the difference between the brightness at the lowest level and the brightness at the next higher level thereto can be reduced while the difference between the reference voltage corresponding to the lowest level and the reference voltage corresponding to the next higher level is increased. As a result, the gray level folding can be prevented in the vicinity of the lowest level of the M-level gray scale.

Further, because the generation of additional reference voltages similar to the correcting reference voltages of the LCD device of the prior art 2 is unnecessary, the above-described problem of the complication of the data line driver circuit does not occur.

Accordingly, the gray level folding can be prevented while the complication of the data line driving circuit is avoided. This means that high-quality time-varying image display in the TN mode can be realized.

In a preferred embodiment of the LCD device according to the second aspect of the invention, when the brightness at the highest level is defined as “brightness(M−1)” and the brightness at the next higher level to the lowest level is defined as “brightness 1”, a ratio of the brightness at the next higher level to the brightness at the highest level, [brightness 1/brightness(M−1)], is equal to 1.2-th power of [1(M−1)] or less.

In another preferred embodiment of the LCD device according to the second aspect of the invention, the brightness difference is set to be equal to or less than 0.1% of the brightness at the highest level.

In still another preferred embodiment of the LCD device according to the second aspect of the invention, the reference voltage corresponding to the highest level is set in such a way that a relative transmittance of the display section is approximately 100%.

In a further preferred embodiment of the LCD device according to the second aspect of the invention, the reference voltage corresponding to the lowest level is set in such a way that gray scale reversal does not occur due to the output voltage corresponding to the lowest level when the display section is viewed from an upper position.

In a still further preferred embodiment of the LCD device according to the second aspect of the invention, the imaginary reference voltage is set at a lowest voltage value in the zero brightness change region.

According to the third aspect of the present invention, still another LCD device is provided, which comprises:

a display section having a predetermined applied voltage-brightness characteristic about an applied voltage to a liquid crystal and a brightness; and

a driver circuit for driving the display section;

wherein the driver circuit generates output voltages whose number is equal to a predetermined gray level number M based on reference voltages, and selects one of the output voltages and outputs the selected one to the display section in response to an inputted image signal, thereby displaying an image on a M-level gray scale from a 0 level as a lowest level to a (M−1) level as a highest level;

the applied voltage-brightness characteristic of the display section comprises a first zero brightness change region and a second zero brightness region, where brightness changes responsive to change of the applied voltage to the liquid crystal are approximately zero, respectively;

the reference voltage corresponding to the highest level is located in the first zero brightness change region, and an imaginary reference voltage which is lower than the reference voltage corresponding to the lowest level is located in the second zero brightness change region;

the reference voltage corresponding to a next lower level to the highest level, which is lower than the highest level by one, is set in such a way that a brightness at the next lower level is lower than a brightness at the highest level by a first predetermined brightness difference; and

the reference voltage corresponding to a next higher level to the lowest level, which is higher than the lowest level by one, is set in such a way that a brightness at the next higher level is higher than a brightness at the lowest level by a second predetermined brightness difference.

The LCD device according to the third aspect of the invention is equivalent to the combination of the LCD devices according to the first and second aspects of the invention. Therefore, the gray level folding can be prevented in both the vicinities of the highest level and the lowest level.

Moreover, because the generation of additional reference voltages similar to the correcting reference voltages of the LCD device of the prior art 2 is unnecessary, the above-described problem of the complication of the data line driver circuit does not occur.

Accordingly, the gray level folding can be prevented while the complication of the data line driving circuit is avoided. This means that high-quality time-varying image display in the TN mode can be realized.

In a preferred embodiment of the LCD device according to the third aspect of the invention, when a brightness at the highest level is defined as “brightness(M−1)” and the brightness at the next lower level to the highest level is defined as “brightness(M−2)”, a ratio of the brightness at the next lower level to the brightness at the highest level, [brightness(M−2)/brightness(M−1)], is in a range from 1.2-th power of [(M−2)/(M−1)] to 3.2-th power thereof.

In another preferred embodiment of the LCD device according to the third aspect of the invention, the first brightness difference is set in a range from 0.5% to 1.2% of the brightness at the highest level.

In still another preferred embodiment of the LCD device according to the third aspect of the invention, the reference voltage corresponding to the highest level is set in a range from 0% to 6% of the reference voltage corresponding to the lowest level.

In a further preferred embodiment of the LCD device according to the third aspect of the invention, the reference voltage corresponding to the lowest level is set at a voltage in such a way to as to realize a desired contrast in a front view of the display section.

In a still further preferred embodiment of the LCD device according to the third aspect of the invention, when the brightness at the highest level is defined as “brightness(M−1)” and the brightness at the next higher level to the lowest level is defined as “brightness 1”, a ratio of the brightness at the next higher level to the brightness at the highest level, [brightness 1/brightness(M−1)], is equal to 1.2-th power of [1/(M−1)] or less.

In still further preferred embodiment of the LCD device according to the third aspect of the invention, the second brightness difference is set to be equal to or less than 0.1% of the brightness at the highest level.

In still further preferred embodiment of the LCD device according to the third aspect of the invention, the reference voltage corresponding to the highest level is set in such a way that a relative transmittance of the display section is approximately 100%.

In a still further preferred embodiment of the LCD device according to the third aspect of the invention, the reference voltage corresponding to the lowest level is set in such a way that gray scale reversal does not occur due to the output voltage corresponding to the lowest level when the display section is viewed from an upper position.

In a still further preferred embodiment of the LCD device according to the third aspect of the invention, the imaginary reference voltage is set at a lowest voltage value in the second zero brightness change region.

### BRIEF DESCRIPTION OF THE DRAWINGS

In order that the present invention may be readily carried into effect, it will now be described with reference to the accompanying drawings.

FIG. 1 is a graph showing the applied voltage-brightness characteristic of the LCD device of the prior art 1 disclosed in the Patent Document 1.

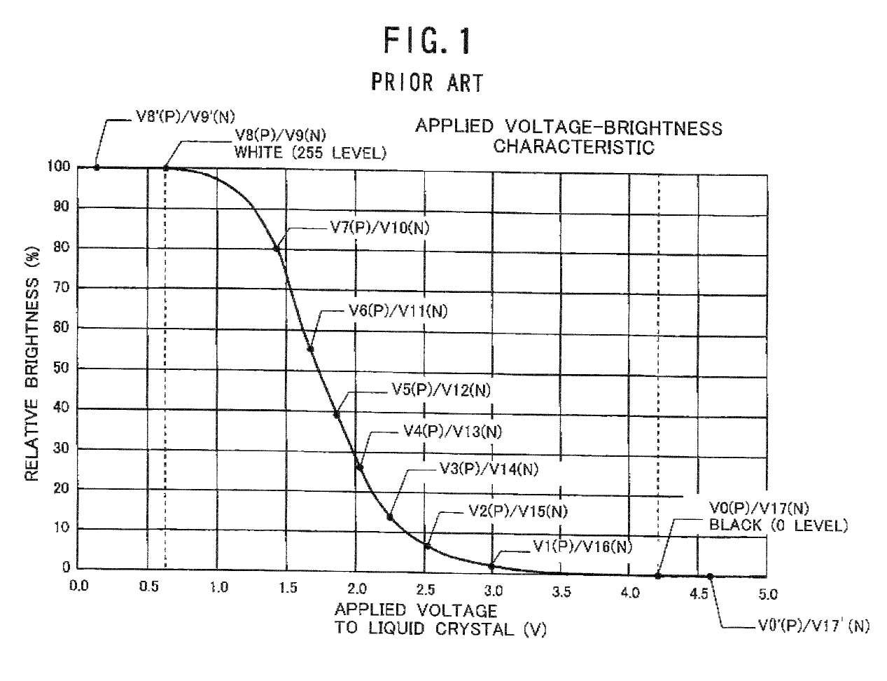

FIG. 2 is a graph showing the gray level-brightness characteristic of the LCD device of the prior art 1 disclosed in the Patent Document 1.

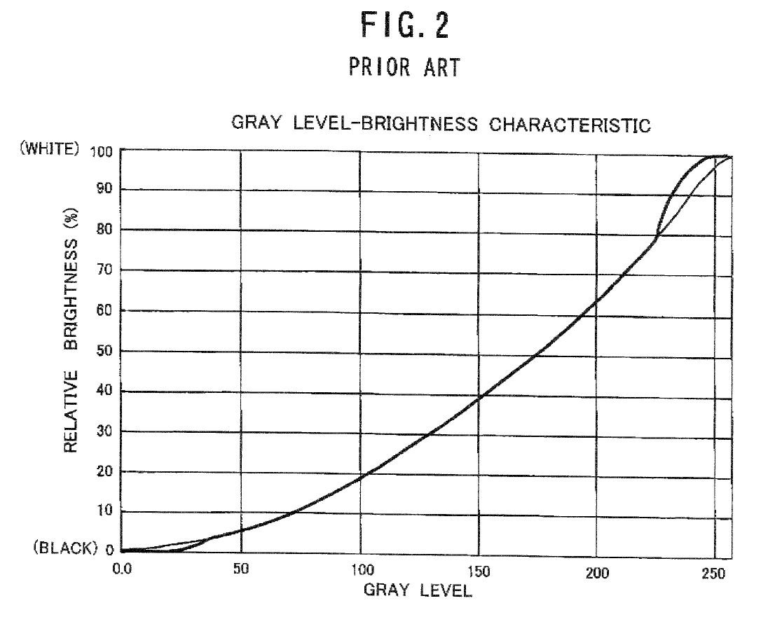

FIG. 3 is a graph showing the applied voltage-brightness characteristic of the LCD device of the prior art 2 disclosed in the Patent Document 1.

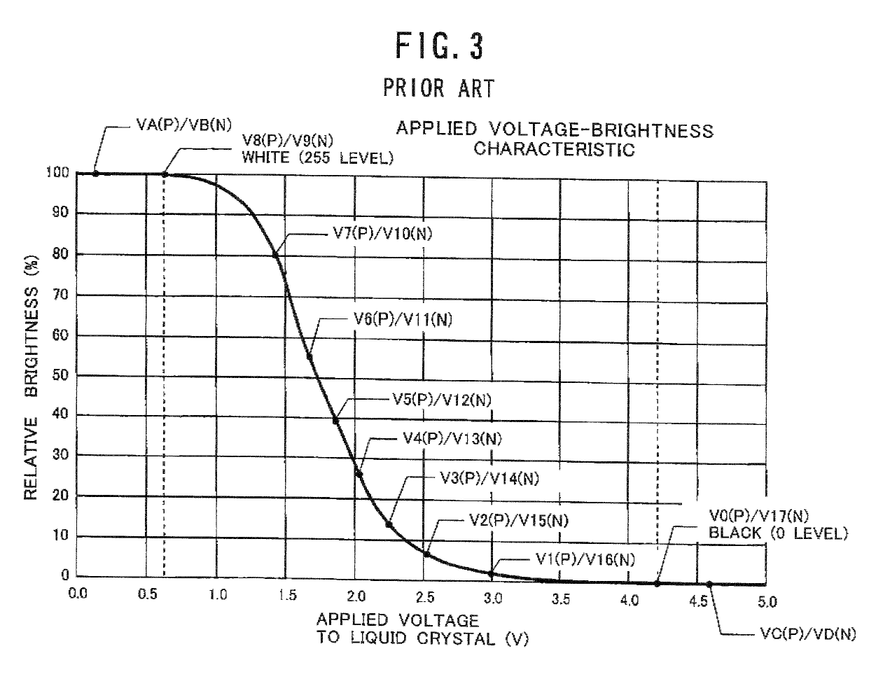

FIG. 4 is a graph showing schematically the response characteristics of the liquid crystal (i.e., brightness change) in the change from black to white and that from white to black in a LCD device operating in the normally white and TN mode.

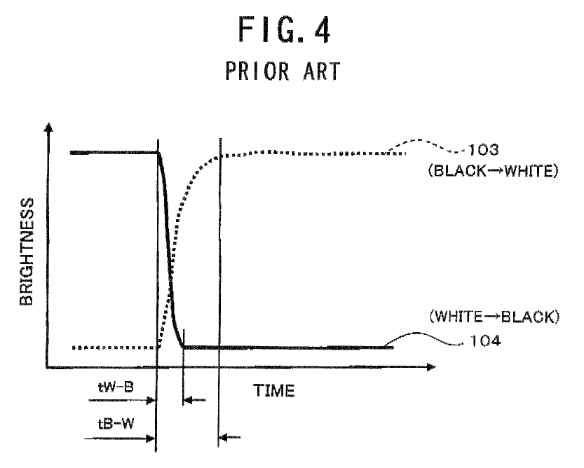

FIG. 5 is a graph showing schematically the relationship between the applied voltage and the response characteristic of the liquid crystal (i.e., brightness change) in a LCD device operating in the normally white and TN mode.

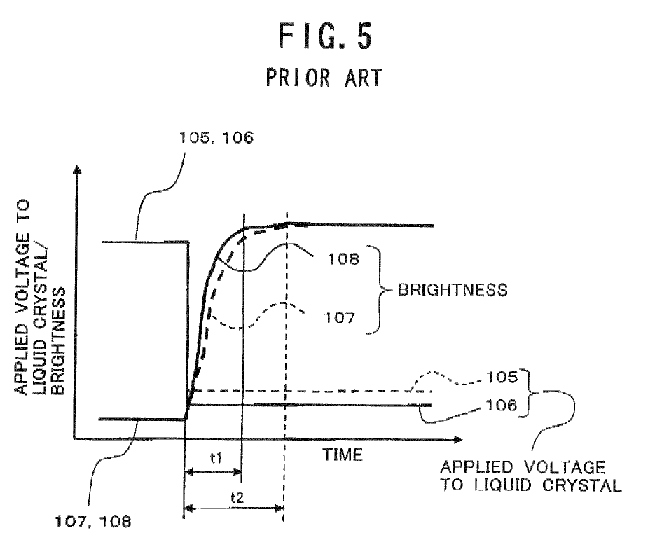

FIG. 6 is a graph showing the applied voltage-brightness characteristic of a LCD device according to a first embodiment of the present invention.

FIG. 7 is a graph showing the gray level-brightness characteristic of the LCD device according to the first embodiment of the present invention.

FIG. 8 is a graph showing the relationship between the falling response time and the end voltage of the falling response of the LCD device according to the first embodiment of the present invention.

FIG. 9 is a graph showing the applied voltage-brightness characteristic of the LCD device according to the first embodiment of the present invention, where the white display region is enlarged.

FIG. 10 is a schematic illustration of a LCD device according to a second embodiment of the present invention, where the device is viewed from the CF substrate side.

FIG. 11 is a graph showing the applied voltage-brightness characteristic of the LCD device according to the second embodiment of the present invention.

FIG. 12 is a graph showing the applied voltage-brightness characteristic of the LCD device according to the second embodiment of the present invention, where the device is viewed from an upper position at a viewing angle of 0°, 10°, 20°, or 30°.

FIG. 13 is a graph showing the applied voltage-brightness characteristic of the LCD device according to a third embodiment of the present invention.

FIG. 14 is a schematic illustration showing the structure of the LCD panel (the display section) and the scanning line and data line driver circuits of the LCD device according to the first embodiment of the present invention.

### DETAILED DESCRIPTION OF THE PREFERRED EMBODIMENTS

Preferred embodiments of the present invention will be described in detail below while referring to the drawings attached.

### First Embodiment

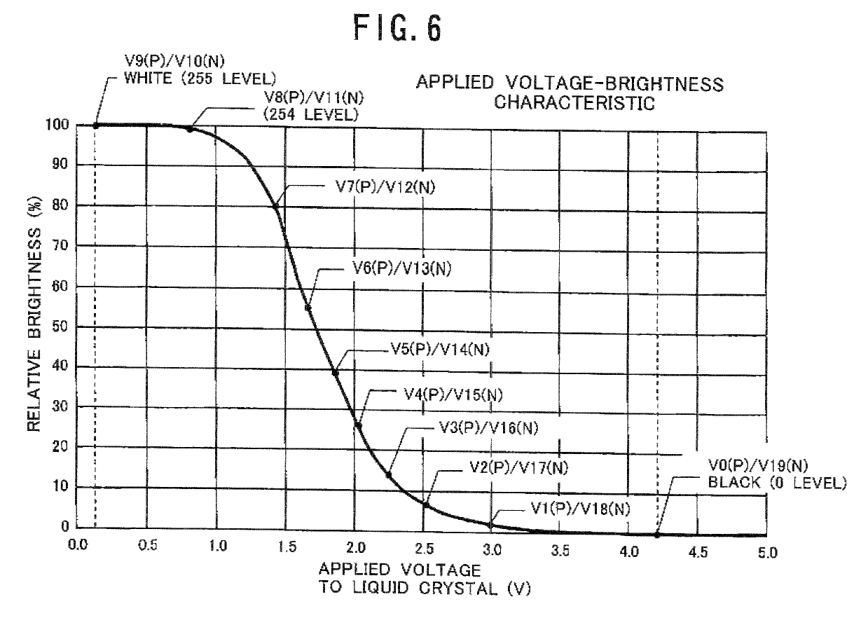

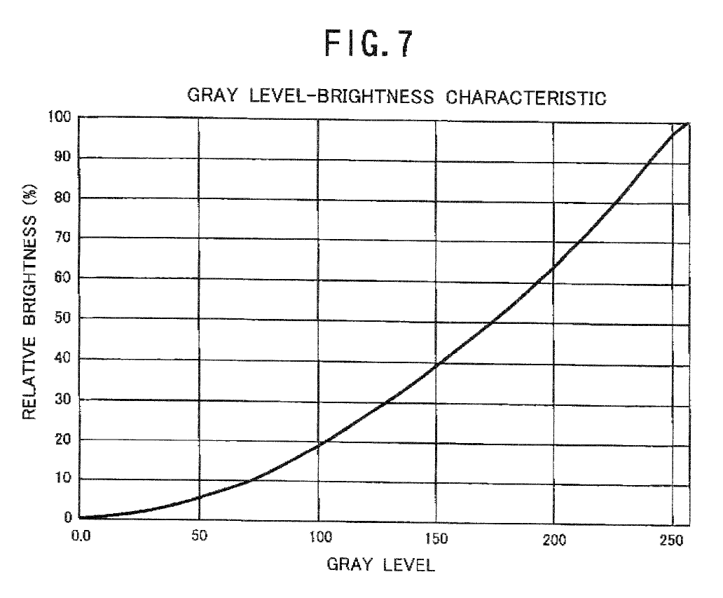

The applied voltage-brightness characteristic of an active-matrix addressing LCD device according to a first embodiment of the invention is shown in FIG. 6, which operates in the normally white and TN mode. The gray level-brightness characteristic used in this LCD device is shown in FIG. 7. This device displays images with 8 bits on a 256-level gray scale from a 0 level as the lowest level to a (255−1) level as the highest level. Therefore, the gray level number M is 256.

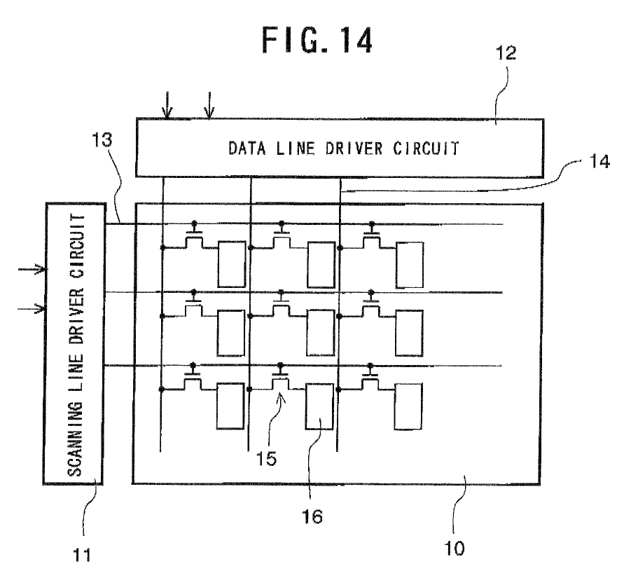

The LCD device according to the first embodiment comprises a LCD panel 10 as the display section, as shown in FIG. 14. The LCD panel 10 has a plurality of pixels arranged in a matrix array. These pixels are defined by scanning lines 13 and data lines (or signal lines) 14 that are arranged on the panel 10 in such a way as to be intersected at right angles. A TFT 15 as a switching element for driving the pixel and a pixel electrode 16 are provided for each of the pixels. The scanning lines 13 are electrically connected to the respective gate electrodes of the TFTs 15. The data lines 14 are electrically connected to the respective drain electrodes of the TFTs 15. The pixel electrodes 16 are electrically connected to the respective source electrodes of the TFTs 15. The panel 10 is driven by the TFTs 15 in the respective pixels, thereby displaying images on the screen of the panel 10.

A scanning line driver circuit 11 and a data line driver circuit 12, which are mounted near the LCD panel 10, are electrically connected to the LCD panel 10 having the above-described structure.

The scanning line driver circuit 11 selects successively the scanning lines 13 in response to an inputted image data.

The data line driver circuit 12 supplies predetermined output voltages corresponding to the inputted image data to the LCD panel 10 by way of the respective data lines 14. Specifically, the data line driver circuit 12 generates the output voltages whose number is equal to the predetermined gray level number 256 based on a plurality of reference voltages. The reference voltages are supplied to the circuit 12 from the outside. Then, the circuit 12 selects one of the output voltages thus generated and outputs the selected one to the LCD panel 10 (i.e., the display section) by way of each data line 14 in response to the inputted image signal. In this way, images are displayed at the 256 gray levels from the 0 level as the lowest level to the 255 level as the highest level.

To display images at the 256 gray levels as shown in FIG. 7 in the LCD device according to the first embodiment, it is usual that reference voltages having 20 levels including the positive and negative polarities (concretely, V0 to V19 in the applied voltage-brightness characteristic of FIG. 6) are supplied to the data line driver circuit 12. The circuit 12 divides each of the spaces among the 20 reference voltages V0 to V19 based on the said reference voltages by a predetermined procedure, thereby generating the output voltages having 256 levels including the positive and negative polarities in total. Thereafter, one of the 256 output voltages corresponding to the inputted image data is selected for each data line 14, and the selected output voltage is sent to the LCD panel 10 by way of each data line 14.

These reference voltages V0 to V19 are determined in the following manner.

Each of the reference voltages V0(P) and V19(N) corresponding to black display (i.e., the 0 level as the lowest gray level) is set at an appropriate voltage value in such a way that a sufficient contrast is realized as desired when viewed from the front of the LCD panel 10. Each of the reference voltages V9(P) and V10(N) corresponding to white display (i.e., the 255 level as the highest gray level) is set at a voltage value within the range from 0% to 6% of the reference voltage V0(P) or V19(N) corresponding to the black display. In other words, each of the reference voltages V9(P) and V10 (N) is set at any voltage value equal to 6% or lower of the voltage value of V0(P) or V19(N), or 0. This is to raise the falling response speed of the liquid crystal.

Furthermore, each of the reference voltages V8(P) and V11(N) corresponding to the next lower level (i.e., the 254 level) to the highest level (white display), which is lower than the highest level by one, is set at a voltage value in such a way that the brightness at the next lower level is lower than the brightness at the highest level by a predetermined brightness difference. The said brightness difference is set in a range from 0.5% to 1.2% of the brightness at the highest level. This is to prevent the gray scale folding from occurring in the vicinity of white.

Next, the reason why the brightness difference between the brightness at the highest level (white, 255 level) and that at the next lower level (254 level) is set in the range from 0.5% to 1.2% of the brightness at the highest level will be explained below.

Generally speaking, with a display device, when the brightness at one level (here, N level) is defined as “brightness N”, the brightness at white (here, W level) is defined as “brightness W”, and the ratio of the brightness N to the brightness W is equal to γ-th power of (N/255), in other words, (brightness N/brightness W)=(N/255)^{γ}, it is ideal that γ has a value of approximately 2.2. However, it is difficult that the value of γ is strictly set at a value of 2.2 for all the gray levels from the 0 level to the 254 level. Therefore, an error of approximately ±1.0 with respect to the value of 2.2 will occur in some of the gray levels.

Accordingly, in consideration of the said variation range of γ, it is supposed that the value of γ varies in the range from 1.2 to 3.2 (=2.2±1.0) in the LCD device according to the first embodiment that display images with 8 bits at 256 gray levels. When the brightness at the next lower level (i.e., 254 level) to the highest one (i.e., 255 level) is defined as “brightness 254”, the brightness at the highest level is defined as “brightness 255”, and the value of γ is 1.2, (brightness 254/brightness 255)=0.995 is established. Therefore, the brightness 254 is lower than the brightness 255 by 0.5% of the brightness 255. When the value of γ is 3.2, (brightness 254/brightness 255)=0.988 is established. Therefore, the brightness 254 is lower than the brightness 255 by 1.2% of the brightness 255. As a result, each of the reference voltages V8(P) and V11(N) at the 254 level is set in such a way that the brightness at the 254 level is lower than that at the 255 level by 0.5% to 1.2% of the brightness at the 255 level.

In the LCD device according to the first embodiment, because of the reason described above, the brightness at the 254 level is set to be lower than that at the 255 level by 0.5% to 1.2% of the brightness at the 255 level. The reference voltages in the intermediate tones (i.e., V1(P) to V8(P) and V11(N) to V18(N)) are respectively set at voltage values in such a way that the gradient or inclination is not zero on the applied voltage-brightness characteristic shown in FIG. 6.

This can be generalized in the following way:

It is supposed that the LCD device according to the first embodiment displays images at M gray levels (in other words, at M shades of gray) from the 0 level as the lowest level to the (M−1) level as the highest level. The brightness at the highest level is defined as “brightness(M−1)”, and the brightness at the next lower level to the highest one is defined as “brightness(M−2)”. In this case, the brightness difference between the brightness(M−2) and the brightness(M−1) is set in such a way that the ratio of the brightness(M−2) to the brightness(M−1), i.e., [brightness(M−2)/brightness(M−1)], is in the range from 1.2-th power of [(M−2)/(M−1)] to 3.2-th power thereof.

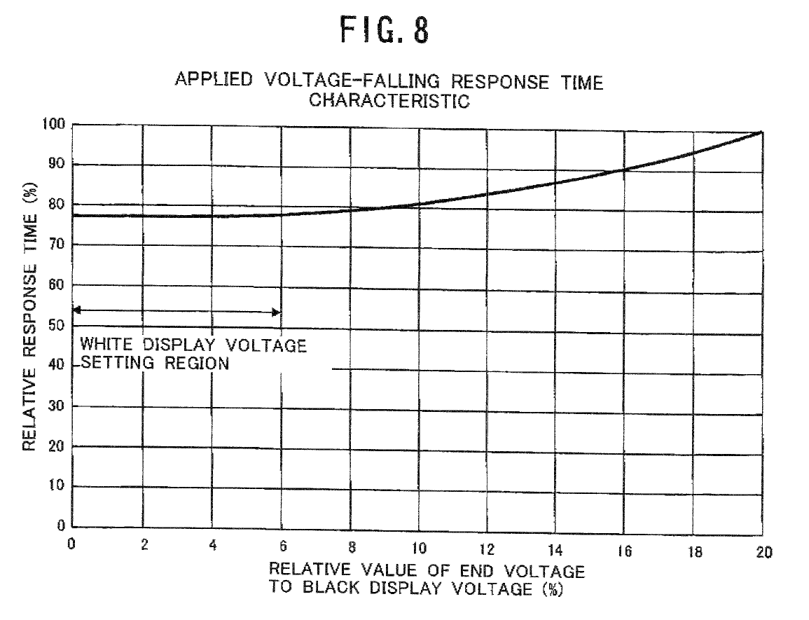

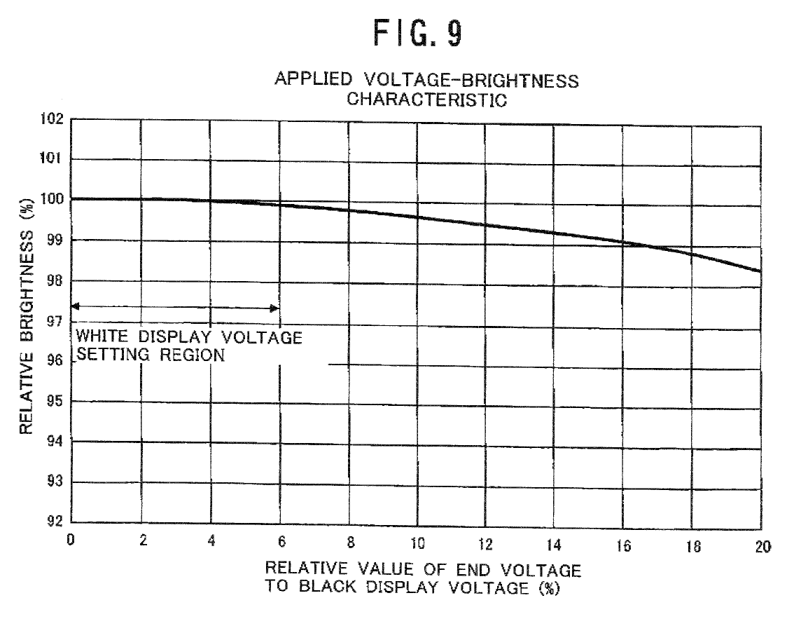

Next, the reason why each of the reference voltages V9(P) and V10(N) corresponding to the highest level (white display) is set in the range from 0% to 6% of the reference voltage V0(P) and V10(N) corresponding to the lowest level will be explained below with reference to FIGS. 8 and 9.

FIG. 8 shows the relationship between the falling response time (from all black to the vicinity of white) and the voltage for white display (255 level) of the LCD device according to the first embodiment of the present invention.

As seen from FIG. 8, the falling response time has a tendency to be shorter as the white display voltage (i.e., the end voltage with respect to the black display voltage) is lowered. However, if the white display voltage enters the range of 6% to 0% of the black display voltage, the falling response time becomes saturated and it does not become shorter any more.

FIG. 9 is an enlarged graph showing the vicinity of the white display voltage of the applied voltage-brightness characteristic (see FIG. 6) of the LCD device according to the first embodiment.

As seen from FIG. 9, even if the relative value of the end voltage to the black display voltage is 10% or less, slight brightness change is still observed. The change of the brightness does not become equal to substantially zero unless the white display voltage (i.e., the end voltage with respect to the black display voltage) becomes equal to 6% of the black display voltage or lower. Since the region where the brightness change is substantially zero (i.e., the brightness change zero region) is a region where the applied voltage-brightness characteristic of FIG. 6 is flat, the alignment state of the liquid crystal molecules is substantially the same within the said region. Accordingly, even if any different voltage value within the brightness change zero region is applied to the liquid crystal, the returning force applied to the liquid crystal molecules is substantially the same.

However, in the region where the relative value of the end voltage to the black display voltage exceeds 6%, the applied voltage-brightness characteristic of FIG. 6 is not flat, and therefore, the alignment state of the liquid crystal molecules will change according to the value of the applied signal voltage. Accordingly, when the signal voltage is applied to the liquid crystal in the region where the relative value of the end voltage to the black display voltage exceeds 6%, the returning force applied to the liquid crystal molecules is weaker than the applied returning force in the region where the relative value of the end voltage to the black display voltage is equal to or less than 6%.

Due to the aforementioned reason, each of the reference voltages V9(P) and V10(N) corresponding to the white display (at the highest level) is set at a voltage value within the range from 0% to 6% of the reference voltage V0(P) or V19(N) corresponding to the black display (at the lowest level). This means that a stronger returning force is applied to the liquid crystal molecules compared with the case where each of the reference voltages V9(P) and V10(N) is set at a voltage greater than 6% of the reference voltage V0(P) or V19(N). As a result, the falling response speed of the liquid crystal can be shortened.

With the LCD device according to the first embodiment of the invention, each of the reference voltages V9(P) and V10(N) corresponding to the highest level is located in the zero brightness change region of the applied voltage-brightness characteristic shown in FIG. 6. Moreover, each of the reference voltages V8(P) and V11(N) corresponding to the next lower level (the 254 level) to the highest level (the 255 level) is set in such a way that the brightness at the 254 level is lower than the brightness at the 255 level by the predetermined brightness difference, where the brightness difference is equal to 0.5% to 1.2% of the brightness at the highest level.

Therefore, the difference between the brightness at the highest level (255 level) and the brightness at the next lower level (254 level) can be reduced while the difference between the reference voltage V9(P) or V10(N) corresponding to the highest level and the reference voltage V8(P) or V11(N) corresponding to the next lower level is respectively increased. As a result, the gray level folding can be prevented in the vicinity of the highest gray level, i.e., the white display.

Furthermore, because the generation of additional reference voltages similar to the correcting reference voltages VA(P), VB(N), VC(P), and VD(N) of the LCD device of the prior art 2 is unnecessary, the above-described problem of the complication of the data line driver circuit 12 does not occur.

Accordingly, the gray level folding can be prevented while the complication of the data line driving circuit 12 is avoided. This means that high-quality time-varying image display in the TN mode can be realized.

### Second Embodiment

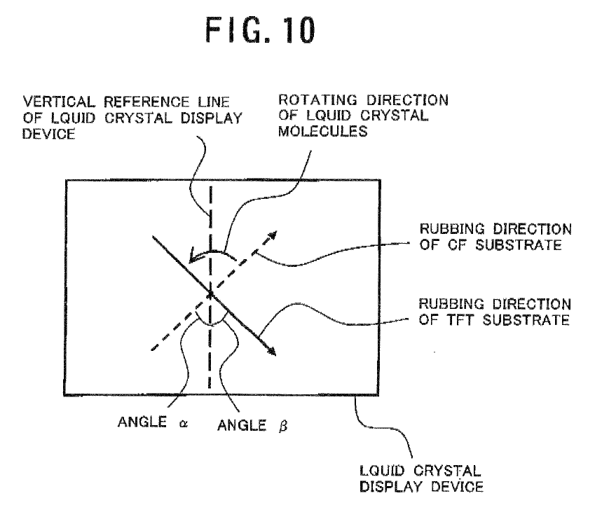

FIG. 10 schematically shows the front view an active-matrix addressing LCD device according to a second embodiment of the present invention, where the display screen of the said device is viewed from the CF substrate side. This device operates in the normally white and TN mode similar to the above-described first embodiment.

Generally, an active-matrix addressing LCD device is constituted by coupling a CF substrate and a TFT substrate. In the TN mode, the alignment directions of the liquid crystal molecules on the CF and TFT substrates are regulated by the alignment films formed respectively on these two substrates. Therefore, the liquid crystal molecules are aligned along the rubbing directions of the CF and TFT substrates. Accordingly, the liquid crystal molecules have pretilt angles in the range of 2° to 10° on the surfaces of the CF and TFT substrates. A chiral agent is added to the liquid crystal to twist the liquid crystal molecules along a single direction.

With the LCD device according to the second embodiment of the invention also, the rubbing directions on the CF and TFT substrates are defined as shown in FIG. 10, where the rubbing direction of the CF substrate and that of the TFT substrate have angles α and β with respect to the vertical reference line of the said device, respectively. Both the angles α and β are set at approximately 45°. Since the chiral agent added to the liquid crystal twists the liquid crystal molecules counterclockwise from the CF substrate to the TFT substrate, the liquid crystal molecules are twisted along the direction of the arrow shown in FIG. 10.

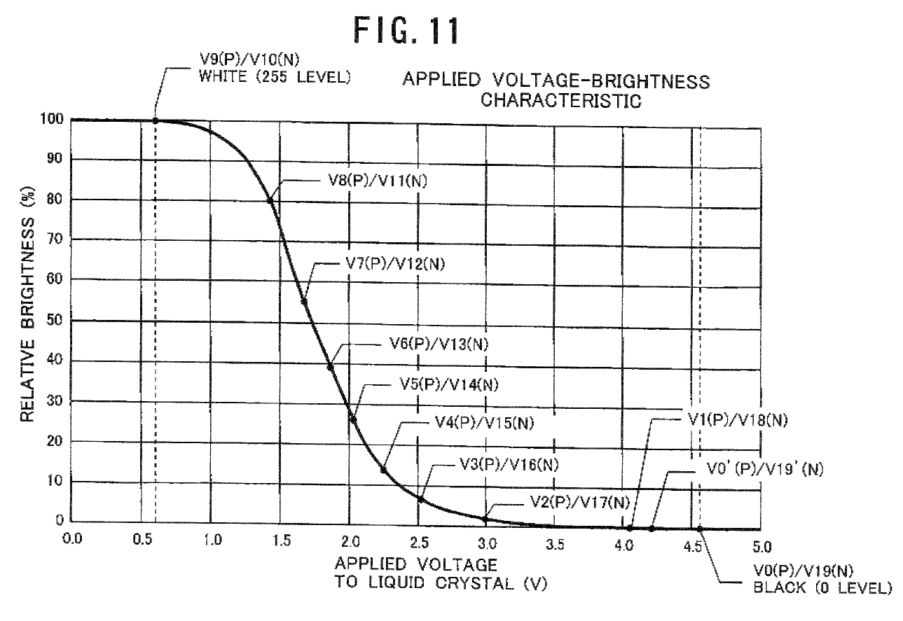

FIG. 11 shows the applied voltage-brightness characteristic of the LCD device according to the second embodiment of the invention, which is viewed from the front thereof.

To display images with 8 bits at 256 gray levels as shown in FIG. 7, similar to the explanation given to the first embodiment, it is usual that reference voltages having 20 levels including the positive and negative polarities (i.e., V0 to V19 in the applied voltage-brightness characteristic of FIG. 11) are supplied to the data line driver circuit 12. The data line driver circuit 12 divides each of the spaces among the reference voltages V0 to V19 based on the said reference voltages by a predetermined procedure, thereby generating the output voltages having 256 levels including the positive and negative polarities. Thereafter, one of the 256 output voltages corresponding to the inputted image data is selected for each data line 14, and the selected output voltage is sent to the LCD panel 10 by way of each data line 14.

In the second embodiment, before setting the reference voltages V0(P) to V19(N), imaginary reference voltages V0′(P) and V19′(N) (which are not used actually) are set at voltage values in such a way that a sufficient contrast is realized in the front view of the LCD panel 10. Subsequently, the reference voltages V0(P) to V19(N) that are actually used are set. In this case, each of the reference voltages V9(P) and V10(N) corresponding to white display (at the 255 level) is set at a voltage value in such a way that the relative transmittance of the panel 10 is approximately 100%.

To realize a good viewing angle characteristic, the setting of the reference voltages V0(P) and V19(N) corresponding to black display (at the 0 level) is performed in the following way:

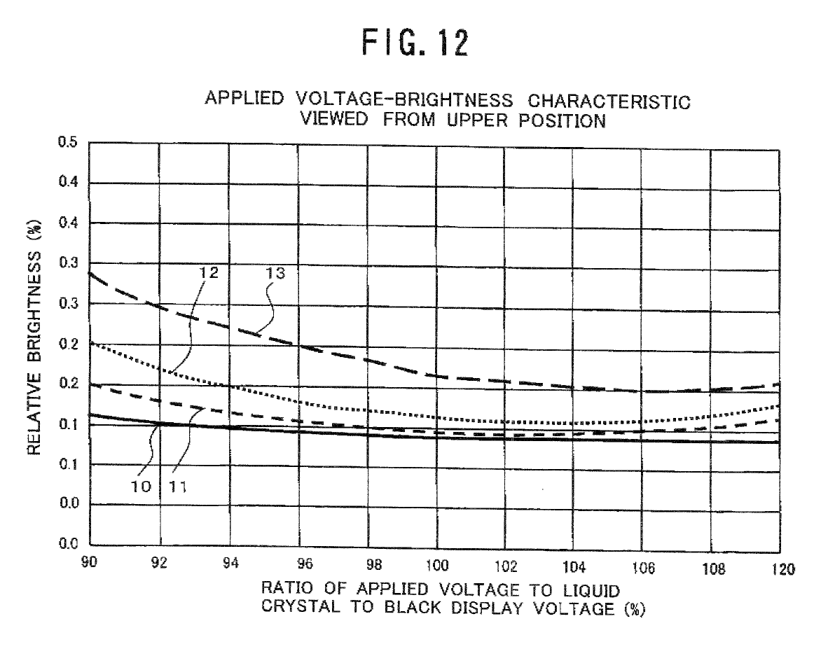

FIG. 12 shows the applied voltage-brightness characteristic of the LCD device according to the second embodiment, which is viewed from an upper position.

Here, the wording “view from an upper position” means that the display screen of the LCD device is viewed obliquely from an upper position with respect to the said screen. As describe above, the LCD device of the second embodiment comprises the CF and TFT substrates whose rubbing directions are defined as shown in FIG. 10, and the liquid crystal molecules are twisted counterclockwise from the rubbing direction of the TFT substrate to the rubbing direction of the CF substrate, as shown in FIG. 10.

Moreover, the term “viewing angle” used in this specification means an angle between a line of sight and the vertical axis planted perpendicularly on the display screen of the LCD panel 10.

In FIG. 12, regarding the applied voltage-brightness characteristic 10 viewed from the front of the display screen (i.e., the viewing angle of 0°), the brightness decreases with the increasing applied voltage to the liquid crystal (which is shown by the ratio with respect to the black display voltage). Each of the imaginary reference voltages V0′(P) and V19′(N) is set at the lowest voltage value where the brightness change is zero.

Regarding the applied voltage-brightness characteristic 11 viewed at a viewing angle of 10°, the applied voltage-brightness characteristic 12 viewed at a viewing angle of 20°, and the applied voltage-brightness characteristic 13 viewed at a viewing angle of 30°, the brightness has respective relative minimum values as the applied voltage to the liquid crystal is increased. All the relative minimum values at the viewing angles of 10°, 20°, and 30° are higher than the imaginary reference voltage V0′(P) or V19′(N).

Then, one of the applied voltage-brightness characteristics 11, 12, and 13 that has the relative minimum value of brightness at the lowest voltage value among them is selected and thereafter, each of the reference voltages V0(P) and V19(N) corresponding to the lowest gray level (i.e., the 0 level, black display) is set at the voltage value where the brightness is relatively minimized on the applied voltage-brightness characteristic 11, 12, or 13 thus selected.

The reference voltages V1(P) and V18(N) corresponding to the next higher level (i.e., the 1 level) to the lowest level (black), which is higher than the lowest level by one, are set to be lower than the imaginary reference voltages V0′(P) and V19′(N), respectively. Moreover, the reference voltages V1(P) and V18(N) are set in such a way that the brightness difference between the next higher level (i.e., the 1 level) and the lowest level (i.e., the 0 level, black) is set to be equal to or less than 0.1% of the brightness at the highest level (i.e., the 255 level, white).

Next, the reason why the brightness difference between the 1 level and the 0 level is set to be equal to or less than 0.1% of the brightness at the highest level will be explained below.

In the LCD device according to the second embodiment also, images are displayed with 8 bits at 256 gray levels, and therefore, it is supposed that the value of γ varies in the range from 1.2 to 3.2 (=2.2±1.0), similar to the aforementioned first embodiment. When the brightness at the next higher level (i.e., 1 level) to the lowest one (i.e., 0 level, black) is defined as “brightness 1”, the brightness at the highest level (i.e., 255 level) is defined as “brightness 255”, and the value of γ is 1.2, (brightness 1/brightness 255)=0.001 is established. When the value of γ is 3.2, (brightness 1/brightness 255)=0.000 is established. Moreover, if the brightness at the lowest level is defined as “brightness 0”, (brightness 0/brightness 255)=0.000 is established in the both cases of γ=1.2 and γ=3.2. Accordingly, the brightness difference between the lowest level (i.e., 0 level) and the next higher level (i.e., 1 level) thereto needs to be set to be equal to or less than 0.1% of the brightness at the highest level (white).

This can be generalized in the following way:

It is supposed that the LCD device according to the second embodiment displays images at M gray levels from the 0 level to the (M−1) level, similar to the aforementioned first embodiment. Then, the brightness at the lowest level is defined as “brightness 0”, and the brightness at the next higher level to the lowest one is defined as “brightness 1”. In this case, the brightness difference between the brightness 1 and the brightness 0 is set in such a way that the ratio of the brightness 0 to the brightness(M−1), i.e., [brightness 1/brightness(M−1)], is equal to 1.2-th power of [1/(M−1)] or lower.

Each of the imaginary reference voltages V0′(P) and V19′(N) is set at the lowest voltage value where the brightness change is zero on the applied voltage-brightness characteristic 10 viewed from the front of the display screen (i e., the viewing angle of 0°). If the reference voltages V1(P) and V18(N) at the 1 level, which are respectively next higher levels to the imaginary reference voltages V0′(P) and V19′(N), are too high, the brightness at the 1 level is never higher than the brightness at the 0 level. Accordingly, the reference voltages V1(P) and V18(N) at the 1 level are set to be lower than the imaginary reference voltages V0′(P) and V19′(N), respectively, and at the same time, the brightness difference between the brightness at the 1 level and the brightness at the 0 level is set to be equal to or less than 0.1% of the brightness at the highest level (i.e., white).

In the LCD device according to the second embodiment, as described above, the brightness values at the viewing angles of 10°, 20°, 30°, where the black display voltage is assigned to the reference voltages V0(P) and V19(N), are lower than the brightness value at the imaginary reference voltages V0′(P) and V19′(N). Therefore, good contrast and good viewing angle characteristics can be realized.

In addition, the reference voltages V1(P) and V18(N) at the 1 level, which is the next higher level to the lowest level (i.e., black), are set to be lower than the imaginary reference voltages V0′(P) and V19′(N). The brightness difference between the 1 level and the 0 level is set to be equal to or less than 0.1% of the brightness at the highest level (i.e., white). Moreover, The reference voltages V2(P) and V17(N) in the intermediate tones are respectively set at voltage values in such a way that the gradient or inclination is not zero on the applied voltage-brightness characteristic shown in FIG. 11. Accordingly, the gray scale folding near the black display voltage is avoided.

With the LCD device according to the second embodiment of the invention, as explained above, the imaginary reference voltages V0′(P) and V19′(N), which are respectively lower than the reference voltages V0(P) and V19(N) corresponding to the lowest level (i.e., the 0 level), are located in the brightness change zero region of the voltage-brightness characteristic of the LCD panel 10. The reference voltages V1(P) and V18(N) corresponding to the next higher level to the lowest level (i.e., the 1 level), which is higher than the lowest level by one, are set to be lower than the imaginary reference voltages V0′(P) and V19′(N), respectively. Moreover, the reference voltages V1(P) and V18(N) corresponding to the 1 level are set in such a way that the brightness at the 1 level is higher than the brightness at the 0 level by the predetermined brightness difference (here, which is equal to 0.1% of the brightness at the highest level or lower).

Therefore, the difference between the brightness at the 0 level and the brightness at the 1 level can be reduced while the difference between the reference voltages V0(P) or V19(N) corresponding to the 0 level and the reference voltage V1(P) or V18(N) corresponding to the 1 level is increased. As a result, gray level folding can be prevented in the vicinity of the lowest level (black).

Furthermore, because the generation of additional reference voltages similar to the correcting reference voltages VA(P), VB(N), VC(P), and VD(N) of the LCD device of the prior art 2 is unnecessary, the above-described problem of the complication of the data line driver circuit 12 does not occur.

Accordingly, the gray level folding can be prevented while the complication of the data line driving circuit 12 is avoided. This means that high-quality time-varying image display in the TN mode can be realized.

In addition, there is an advantage that good viewing angle characteristics can be realized at the viewing angles from the upper, lower, right and left positions (in particular, from the upper position) and that gray scale reversal does not occur at the viewing angle from the upper position.

### Third Embodiment

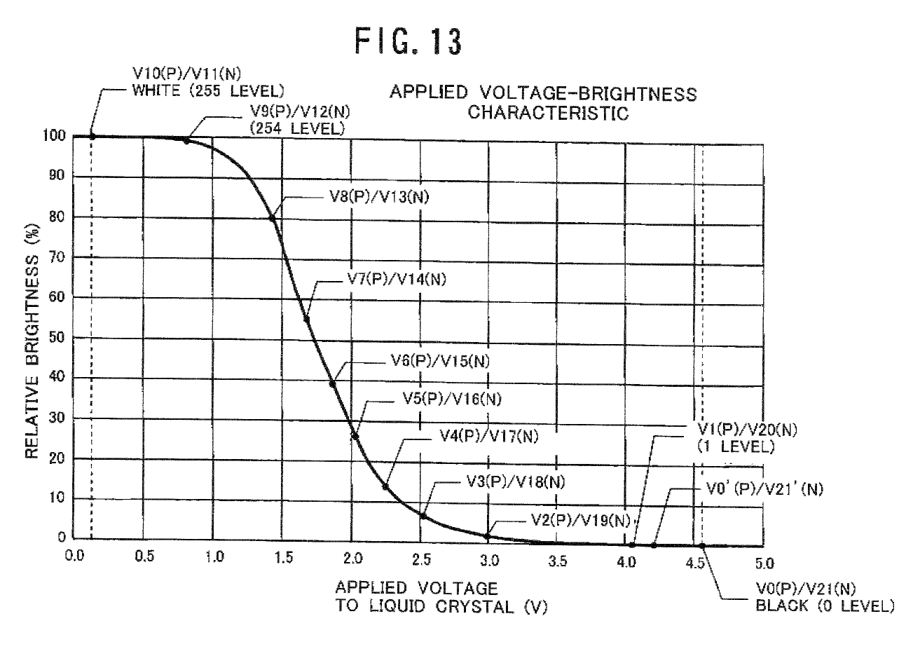

FIG. 13 shows the applied voltage-brightness characteristic of the LCD device according to a third embodiment of the invention, which is viewed from the front of the said device. This device operates in the normally white and TN mode similar to the above-described first embodiment.

To display images with 8 bits at 256 gray levels as shown in FIG. 7, reference voltages having 22 levels including the positive and negative polarities (i.e., V0 to V21 in the applied voltage-brightness characteristic of FIG. 13) are applied to the data line driver circuit 12. The data line driver circuit 12 divides each of the spaces among the reference voltages V0 to V21 based on the said reference voltages by a predetermined procedure, thereby generating the output voltages having 256 levels including the positive and negative polarities. Thereafter, one of the 256 output voltages corresponding to the inputted image data is selected for each data line 14, and the selected output voltage is sent to the LCD panel 10 by way of each data line 14.

In the third embodiment, before setting the reference voltages V0(P) to V21(N), imaginary reference voltages V0′(P) and V21′(N) (which are not used actually) are set at voltage values in such a way that sufficient contrasts are realized when viewed from the front of the LCD panel 10. This is similar to the aforementioned second embodiment. Subsequently, the setting for the reference voltages V0(P) to V21(N) that are actually used is performed.

Each of the reference voltages V10(P) and V11(N) corresponding to the highest gray level (i.e., white, 255 level) is set at a voltage within the range from 0% to 6% of the imaginary reference voltage V0′(P) or V21′(N). The reason why the imaginary reference voltages V0′(P) and V21′(N) are used here is that the imaginary reference voltages V0′(P) and V21′(N) in the third embodiment are equivalent respectively to the reference voltages V0(P) and V19(N) corresponding to the lowest level (i.e., black, 0 level) in the aforementioned first embodiment.

The reference voltages V9(P) and V12(N) corresponding to the next lower level (i.e., 254 level) to the highest level (i.e., white, 255 level) is set to be lower than the brightness at the highest level by a predetermined brightness difference. Moreover, the brightness difference is set in the range from 0.5% to 1.2% of the brightness at the highest level. This is to prevent the gray scale folding in the vicinity of the white display voltage, the reason of which is the same as the aforementioned first embodiment.

The reference voltages V0(P) and V21(N) corresponding to the lowest gray level are set in the same manner as used for the reference voltages V0(P) and V19(N) corresponding to the lowest level described in the aforementioned second embodiment, respectively. The reference voltages V1(P) and V20(N) corresponding to the next higher level (i.e., the 1 level) to the lowest gray level is set in the same manner as used for the reference voltages V1(P) and V18(N) corresponding to the 1 level described in the aforementioned second embodiment, respectively.

As explained above, the LCD device according to the third embodiment is equivalent to the combination of the LCD devices according to the aforementioned first and second embodiments. Therefore, the said device has the advantages of both the first and second embodiments.

Specifically, because of the same reason as described for the LCD device according to the first embodiment, the gray level folding can be prevented in the vicinity of the highest level (i.e., white) and the falling response time can be shortened. Moreover, because of the same reason as described for the LCD device according to the second embodiment, good contrast and good viewing angle characteristics can be realized and the gray level folding can be prevented in the vicinity of the lowest level (i.e., black). Furthermore, because the generation of additional reference voltages similar to the correcting reference voltages VA(P), VB(N), VC(P), and VD(N) of the LCD device of the prior art 2 is unnecessary, the above-described problem of the complication of the data line driver circuit 12 does not occur.

Accordingly, the gray level folding can be prevented in the vicinities of the highest and lowest levels (i.e., black and white) while the complication of the data line driving circuit 12 is avoided. This means that high-quality time-varying image display in the TN mode can be realized.

Furthermore, there is an additional advantage that good viewing angle characteristics can be realized at the viewing angles from the upper, lower, right and left positions (in particular, from the upper position) and that gray scale reversal does not occur at the viewing angle from the upper position.

### Other Embodiments

The above-described first to third embodiments are preferred examples of the present invention. Therefore, needless to say, the present invention is not limited to these embodiments and any modification is applicable to them.

For example, although the LCD device displays images with 8 bits at 256 gray levels in the above-described first to third embodiments, the invention is not limited to this. The present invention may be applied to any LCD devices that display images at any gray levels other than 256 levels. The invention is applicable to the cases where images are displayed at M gray levels from the 0 level as the lowest level to the (M−1) level as the highest level, where M is a positive integer greater than unity.

While the preferred forms of the present invention have been described, it is to be understood that modifications will be apparent to those skilled in the art without departing from the spirit of the invention. The scope of the present invention, therefore, is to be determined solely by the following claims.

What is claimed is:

1. A liquid crystal display device comprising:
a display section having a predetermined applied voltage-brightness characteristic about an applied voltage to a liquid crystal and a brightness; and
a driver circuit for driving the display section;
wherein the driver circuit generates output voltages whose number is equal to a predetermined gray level number M based on reference voltages, and selects one of the output voltages and outputs the selected one to the display section in response to an inputted image signal, thereby displaying an image on an M-level gray scale from a 0 level as a lowest level to an (M−1) level as a highest level;
the applied voltage-brightness characteristic of the display section comprises a zero brightness change region where brightness change responsive to change of the applied voltage to the liquid crystal is approximately zero, and the reference voltage corresponding to the highest level of the gray scale is located in the zero brightness change region; and
the reference voltage corresponding to a next lower level to the highest level, which is lower than the highest level by one, is set in such a way that a brightness at the next lower level is lower than a brightness at the highest level by a predetermined brightness difference.

2. The device according to claim 1, wherein when the brightness at the highest level is defined as “brightness(M−1)” and the brightness at the next lower level to the highest level is defined as “brightness(M−2)”, a ratio of the brightness at the next lower level to the brightness at the highest level, [brightness(M−2)/brightness(M−1)], is in a range from 1.2-th power of [(M−2)/(M−1)] to 3.2-th power thereof.

3. The device according to claim 1, wherein the brightness difference is set in a range from 0.5% to 1.2% of the brightness at the highest level.

4. The device according to claim 1, wherein the reference voltage corresponding to the highest level is set in a range from 0% to 6% of the reference voltage corresponding to the lowest level.

5. A liquid crystal display device comprising:
a display section having a predetermined applied voltage-brightness characteristic about an applied voltage to a liquid crystal and a brightness; and
a driver circuit for driving the display section;
wherein the driver circuit generates output voltages whose number is equal to a predetermined gray level number M based on reference voltages, and selects one of the output voltages and outputs the selected one to the display section in response to an inputted image signal, thereby displaying an image on an M-level gray scale from a 0 level as a lowest level to an (M−1) level as a highest level;
the applied voltage-brightness characteristic of the display section comprises a zero brightness change region where brightness change responsive to change of the applied voltage to the liquid crystal is approximately zero, and an imaginary reference voltage lower than the reference voltage corresponding to the lowest level is located in the zero brightness change region; and
the reference voltage corresponding to a next higher level to the lowest level, which is higher than the lowest level by one, is set to be lower than the imaginary reference voltage and is set in such a way that a brightness at the next higher level is higher than a brightness at the lowest level by a predetermined brightness difference.

6. The device according to claim 5, wherein when the brightness at the highest level is defined as “brightness(M−1)” and the brightness at the next higher level to the lowest level is defined as “brightness 1”, a ratio of the brightness at the next higher level to the brightness at the highest level, [brightness 1/brightness(M−1)], is equal to 1.2-th power of [1/(M−1)] or less.

7. The device according to claim 5, wherein the brightness difference is set to be equal to or less than 0.1% of the brightness at the highest level.

8. The device according to claim 5, wherein the reference voltage corresponding to the highest level is set in such a way that a relative transmittance of the display section is approximately 100%.

9. The device according to claim 5, wherein the imaginary reference voltage is set at a lowest voltage value in the zero brightness change region.

10. A liquid crystal display device is provided, which comprises:
a display section having a predetermined applied voltage-brightness characteristic about an applied voltage to a liquid crystal and a brightness; and
a driver circuit for driving the display section;
wherein the driver circuit generates Output voltages whose number is equal to a predetermined gray level number M based on reference voltages, and selects one of the output voltages and outputs the selected one to the display section in response to an inputted image signal, thereby displaying an image on a M-level gray scale from a 0 level as a lowest level to a (M−1) level as a highest level;
the applied voltage-brightness characteristic of the display section comprises a first zero brightness change region and a second zero brightness region, where brightness changes responsive to change of the applied voltage to the liquid crystal are approximately zero, respectively;
the reference voltage corresponding to the highest level is located in the first zero brightness change region, and an imaginary reference voltage which is lower than the reference voltage corresponding to the lowest level is located in the second zero brightness change region;
the reference voltage corresponding to a next lower level to the highest level, which is lower than the highest level by one, is set in such a way that a brightness at the next lower level is lower than a brightness at the highest level by a first predetermined brightness difference; and
the reference voltage corresponding to a next higher level to the lowest level, which is higher than the lowest level by one, is set in such a way that a brightness at the next higher level is higher than a brightness at the lowest level by a second predetermined brightness difference.

11. The device according to claim 10, wherein when a brightness at the highest level is defined as “brightness(M−1)” and the brightness at the next lower level to the highest level is defined as “brightness(M−2)”, a ratio of the brightness at the next lower level to the brightness at the highest level, [brightness(M−2)/brightness(M−1)], is in a range from 1.2-th power of [(M−2)/(M−1)] to 3.2-th power thereof.

12. The device according to claim 10, wherein the first brightness difference is set in a range from 0.5% to 1.2% of the brightness at the highest level.

13. The device according to claim 10, wherein the reference voltage corresponding to the highest level is set in a range from 0% to 6% of the reference voltage corresponding to the lowest level.

14. The device according to claim 10, wherein when the brightness at the highest level is defined as “brightness(M−1)” and the brightness at the next higher level to the lowest level is defined as “brightness 1”, a ratio of the brightness at the next higher level to the brightness at the highest level, [brightness 1/brightness(M−1)], is equal to 1.2-th power of [1/(M−1)] or less.

15. The device according to claim 10, wherein the second brightness difference is set to be equal to or less than 0.1% of the brightness at the highest level.

16. The device according to claim 10, wherein the reference voltage corresponding to the highest level is set in such a way that a relative transmittance of the display section is approximately 100%.

17. The device according to claim 10, wherein the imaginary reference voltage is set at a lowest voltage value in the second zero brightness change region.
